(19) United States
(12) Patent Application Publication
(10) Pub. No.: US 2025/0312851 A1
(43) Pub. Date: Oct. 9, 2025

(54) METHOD AND PLANNING DEVICE FOR PLANNING A LOCALLY SELECTIVE IRRADIATION OF A WORKING REGION WITH AT LEAST ONE ENERGY BEAM, AND METHOD AND MANUFACTURING DEVICE FOR THE ADDITIVELY MANUFACTURING COMPONENTS FROM A POWDER MATERIAL

(71) Applicant: TRUMPF Laser- und Systemtechnik SE, Ditzingen (DE)

(72) Inventor: Bernhard Gutmann, Pfaffenhofen a.d. Glonn (DE)

(21) Appl. No.: 19/240,010

(22) Filed: Jun. 17, 2025

Related U.S. Application Data
(63) Continuation of application No. PCT/EP2023/083184, filed on Nov. 27, 2023.

(30) Foreign Application Priority Data
Dec. 21, 2022 (DE) 10 2022 134 338.3

(51) Int. Cl. B22F 10/366; B22F 12/41; B22F 12/49; B33Y 10/00; B33Y 30/00

(52) U.S. Cl. CPC B22F 10/366; B22F 12/41; B22F 12/49; B33Y 10/00; B33Y 30/00

(57) ABSTRACT

A method provides for planning a locally selective irradiation of a working region with at least one energy beam in order to produce, by the at least one energy beam, at least one component layer by layer from a plurality of powder material layers of a powder material arranged chronologically one after another in a layer sequence in the working region. The method includes: determining, for at least one powder material layer based on at least two sequence criteria, a chronological irradiation sequence of an irradiation of a plurality of irradiation regions with the at least one energy beam; using, as a first sequence criterion, a first irradiation chronology; using, as a second sequence criterion, a second irradiation chronology; and obtaining an irradiation plan for the locally selective irradiation of the working region with the at least one energy beam in the at least one powder material layer.

### CROSS REFERENCE TO RELATED APPLICATIONS

This application is a continuation of International Application No. PCT/EP2023/083184 (WO 2024/132388 A1), filed on Nov. 27, 2023, and claims benefit to German Patent Application No. DE 10 2022 134 338.3, filed on Dec. 21, 2022. The aforementioned applications are hereby incorporated by reference herein.

### FIELD

The invention relates to a method and a planning device for planning a locally selective irradiation of a working region with at least one energy beam, and to a method and a manufacturing device for the additive manufacturing of components from a powder material.

### BACKGROUND

A locally selective irradiation of a working region with an energy beam in order to produce, by means of the energy beam, at least one component layer by layer from a plurality of powder material layers of a powder material arranged chronologically one after another in a layer sequence in the working region can be planned in such a way that different irradiation regions within a powder material layer are irradiated chronologically one after the other against a predetermined shielding gas flow direction above the working region. In this way, any impairment of irradiation regions that have not yet been irradiated by material carried out of irradiated irradiation regions by the shielding gas flow is at least largely avoided. However, a coating device, which is provided to apply a respective next powder material layer to the working region, can typically only start the coating process when the irradiation of the last irradiation region of the previous powder material layer has also been completed. This stands in the way of a further increase in productivity.

If a plurality of energy beams are used to irradiate the working region, each energy beam can be assigned a respective displacement region in the working region, wherein provision can be made for irradiation regions arranged within the same displacement region in each case to be irradiated against the predetermined shielding gas flow direction. However, it may occur in this case that energy beams in neighboring displacement regions operate at too short a distance from one another such that a first irradiation region currently being irradiated by a first energy beam is adversely affected by the processing of a second irradiation region irradiated by a second energy beam in the vicinity. An adverse effect can be caused in particular by a trail or plume of smoke from the second energy beam defocusing the first energy beam or by material ejected from the second irradiation region, for example by spatter. In principle, this problem can at least be alleviated by introducing waiting times with respect to the irradiation with the various energy beams; however, such waiting times result in a not inconsiderable loss of productivity, wherein the irradiation of the working region suffers a reduced time efficiency.

### SUMMARY

In an embodiment, the present disclosure provides a method for planning a locally selective irradiation of a working region with at least one energy beam in order to produce, by the at least one energy beam, at least one component layer by layer from a plurality of powder material layers of a powder material arranged chronologically one after another in a layer sequence in the working region. The method includes: determining, for at least one powder material layer based on at least two sequence criteria, a chronological irradiation sequence of an irradiation of a plurality of irradiation regions with the at least one energy beam; using, as a first sequence criterion, a first irradiation chronology where irradiation regions of the plurality of irradiation region which have a smaller transverse axis coordinate value along a transverse axis oriented transverse to a predetermined shielding gas flow direction over the working region are irradiated chronologically before irradiation regions which have a larger transverse axis coordinate value along the transverse axis; using, as a second sequence criterion, a second irradiation chronology where irradiation regions of the plurality of irradiation regions which have a larger flow axis coordinate value along a flow axis pointing in the shielding gas flow direction are irradiated chronologically before irradiation regions which have a smaller flow axis coordinate value along the flow axis; and obtaining an irradiation plan for the locally selective irradiation of the working region with the at least one energy beam in the at least one powder material layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a manufacturing device for additively manufacturing components from a powder material with an exemplary embodiment of a planning device;

FIG. 2 shows a schematic representation of an exemplary embodiment of a method for planning a locally selective irradiation of a working region with at least one energy beam;

FIG. 3 shows a schematic representation of a first application of the planning method according to FIG. 2 in a working region; and

FIG. 4 shows a schematic representation of a second application of the planning method according to FIG. 2 in a working region.

### DETAILED DESCRIPTION

Embodiments of the present disclosure create a method and a planning device for planning a locally selective irradiation of a working region with at least one energy beam, and a method and a manufacturing device for additively manufacturing components from a powder material, wherein the disadvantages mentioned are reduced or preferably avoided.

The embodiments create a method—and in a particular embodiment a computer-implemented method, hereinafter also referred to as a planning method—for planning—in a particular embodiment in a computer-implemented manner—a locally selective irradiation of a working region with at least one energy beam, in order to produce, by means of the at least one energy beam, at least one component layer by layer from a plurality of powder material layers of a powder material arranged chronologically one after another in a layer sequence in the working region, wherein a chronological irradiation sequence of an irradiation of a plurality of irradiation regions with the at least one energy beam is determined for at least one powder material layer on the basis of at least two sequence criteria, wherein the fact that irradiation regions which have a smaller transverse axis coordinate value along a transverse axis oriented transverse to a predetermined shielding gas flow direction over the working region are irradiated chronologically before irradiation regions which have a larger transverse axis coordinate value along the transverse axis is used as a first sequence criterion, wherein the fact that irradiation regions which have a larger flow axis coordinate value along a flow axis pointing in the shielding gas flow direction are irradiated chronologically before irradiation regions which have a smaller flow axis coordinate value along the flow axis is used as a second sequence criterion. In particular embodiments, an irradiation plan is obtained in this manner for the locally selective irradiation of the working region with the at least one energy beam in the at least one powder material layer. In particular embodiments, the implementation of the first sequence criterion allows for an ordered irradiation of the various irradiation regions transverse to the shielding gas flow direction and thus in particular along an axis along which a coating device is typically displaced in order to arrange a new powder material layer on the working region. This, in turn, now advantageously enables an increase in manufacturing productivity, in that the irradiation sequence can be selected in particular in such a way that the coating device can already start applying the new powder material layer while irradiation regions of the previous powder material layer are still being irradiated.

In particular embodiments, the chronological irradiation sequence is determined on the basis of exactly two sequence criteria, namely—exclusively—the first sequence criterion and the second sequence criterion.

In one embodiment, the first sequence criterion and the second sequence criterion are weighted. In particular embodiments, it is possible that the first sequence criterion is weighted more heavily than the second sequence criterion such that the sequence of irradiation of the irradiation regions is determined primarily along the transverse axis and only secondarily against the flow axis. In one embodiment, the sequence criteria are explicitly weighted, in particular embodiments by specifying certain weighting factors. In another embodiment, the sequence criteria are implicitly weighted, in particular by predetermining decision rules for determining the chronological sequence, from which a corresponding weighting results.

In particular embodiments, the transverse axis extends perpendicular to the flow axis. In particular embodiments, the transverse axis and the flow axis span a Cartesian coordinate system in the plane of the working region, wherein in the following, without limiting the generality, the transverse axis is also referred to as the x-axis and the flow axis is also referred to as the y-axis. Accordingly, transverse axis coordinate values are also referred to as x-coordinate values and flow axis coordinate values are also referred to as y-coordinate values.

In particular embodiments, the y-coordinate values on the flow axis increase in the shielding gas flow direction. In particular embodiments, an irradiation region with a larger y-coordinate value is arranged downstream of an irradiation region with a smaller y-coordinate value in the shielding gas flow direction; conversely, an irradiation region with a smaller y-coordinate value is arranged upstream of an irradiation region with a larger y-coordinate value in the shielding gas flow direction. A first irradiation region, which is arranged upstream of a second irradiation region, is first swept by a determined volume element of the shielding gas flow before the determined volume element reaches the second irradiation region. The second irradiation region, which is swept by the determined volume element after the first irradiation region, is arranged downstream of the first irradiation region.

In one embodiment, an irradiation region is assigned its respective coordinate value at the outermost edge of the irradiation region along the respective coordinate. In particular embodiments, the x-coordinate value assigned to an irradiation region for the purpose of determining the irradiation sequence is the smallest x-coordinate value of the irradiation region extended in a planar manner in the working region; alternatively or additionally, the y-coordinate value assigned to an irradiation region for the purpose of determining the irradiation sequence is the largest y-coordinate value of the irradiation region.

Alternatively, in another embodiment, a center of gravity or center point of the irradiation region under consideration can be used to assign the coordinate values in each case.

In the context of the present technical teaching, an irradiation region is understood to be a region or section of the working region in which powder material is intended to be solidified by irradiation with an energy beam. In particular embodiments, a plurality of irradiation regions are arranged on the working region, which are in particular spaced apart and separated from one another by powder material that is not to be solidified, i.e., in particular regions that are not to be irradiated. In particular, the different irradiation regions are separate from one another.

Different irradiation regions of the plurality of irradiation regions can be assigned to different components. Alternatively or additionally, different irradiation regions of the plurality of irradiation regions can be assigned to a common component; the different irradiation regions then, in particular embodiments, form islands of the common component on the working region.

Additively or generatively manufacturing or producing a component is understood to mean in particular embodiments building up a component layer by layer from powder material, in particular a powder bed-based method for producing a component in a powder bed, in particular a manufacturing method selected from a group consisting of selective laser sintering, laser metal fusion (LMF), direct metal laser melting (DMLM), laser net shaping manufacturing (LNSM), (selective) electron beam melting ((S) EBM), and laser engineered net shaping (LENS). Accordingly, the manufacturing device is designed in particular embodiments to perform at least one of the above-mentioned additive or generative manufacturing methods.

The at least one energy beam is in particular embodiments selected from a group consisting of an electromagnetic beam, in particular an optical working beam, in particular a laser beam, and a particle beam, in particular an electron beam. The energy beam can be continuous or pulsed, in particular embodiments continuous laser radiation or pulsed laser radiation. In one embodiment, all energy beams are laser beams.

In particular embodiments, a locally selective irradiation of a working region with a plurality of energy beams can be planned as part of the planning method in order to produce, by means of the plurality of energy beams, a component layer by layer from a plurality of powder material layers of a powder material arranged chronologically one after another in a layer sequence in the working region.

In particular embodiments, a chronological irradiation sequence of the plurality of irradiation regions with the at least one energy beam is defined for a plurality of the powder material layers in each case. In particular embodiments, an irradiation plan is thus obtained for a plurality of the powder material layers. In particular embodiments, this procedure is carried out for all powder material layers of the plurality of powder material layers. In particular embodiments, an irradiation plan is thus obtained for all powder material layers. In particular embodiments, the method is carried out iteratively-powder material layer by powder material layer.

According to a further development of embodiments of the invention, the transverse axis is aligned along a coating displacement direction of a coating device designed for coating the working region with powder material. In particular embodiments in this manner, a chronological overlap can be advantageously created between the coating of the working region with powder material and the irradiation of the working region with the at least one energy beam, wherein, in particular embodiments, the coating device, on a first side of the working region, already begins with the application of the next powder material layer from a rest position, while, on a second side opposite the first side along the coating displacement direction, irradiation regions are still being irradiated with the at least one energy beam. This allows for a particularly high level of productivity in manufacturing. In order to coat the working region with powder material, the coating device is displaced from its rest position from the first side to the second side of the working region; in particular embodiments, it is then displaced back to the rest position afterwards. In particular embodiments, the x-coordinate value on the transverse axis increases from the first side, on which the coating device is arranged in its rest position, in the direction of the opposite second side. Thus, those irradiation regions to which lower x-coordinate values are assigned are arranged closer to the rest position of the coating device than those irradiation regions to which higher x-coordinate values are assigned.

According to a further development of embodiments of the invention, the irradiation regions are successively sorted into the irradiation sequence, wherein at least one test irradiation region with the smallest x-coordinate value is sought from the irradiation regions not yet sorted into the irradiation sequence, wherein the test irradiation region is sorted into the irradiation sequence if the test irradiation region can be unambiguously determined and no further irradiation region not yet sorted into the irradiation sequence is arranged in a first blocking region in the shielding gas flow direction downstream of the test irradiation region. By searching for the test irradiation region with the smallest x-coordinate value, it is ensured that, primarily, the irradiation region closest along the transverse axis will always be the next irradiation region to be irradiated from a chronological perspective in the irradiation sequence. The cumulatively applied criterion—also referred to below as the shadow casting criterion—that no other irradiation region that has not yet been sorted into the irradiation sequence may be arranged in the first blocking region means that, secondarily, the sequence of the irradiation regions is selected in the opposite direction to the shielding gas flow direction, thus avoiding in particular the impairment of regions of the powder material layer that have not yet been irradiated by spatter carried away in the shielding gas flow direction.

According to a further development of embodiments of the invention, if the test irradiation region cannot be determined unambiguously, that irradiation region of the irradiation regions not yet sorted into the irradiation sequence is determined as the test irradiation region which has the smallest x-coordinate value and at the same time the largest y-coordinate value. If multiple irradiation regions with an identical smallest x-coordinate values are found so that the assignment of the test irradiation region is ambiguous, the irradiation region that also has the largest y-coordinate value is thus determined as the test irradiation region from the irradiation regions in question that have the same smallest x-coordinate value. This instruction in particular embodiments implicitly implements an irradiation against the shielding gas flow direction as a secondary sequence criterion.

According to a further development of embodiments of the invention, if a further irradiation region not yet sorted into the irradiation sequence is arranged in the first blocking region downstream of the test irradiation region in the shielding gas flow direction, the test irradiation region is provisionally disregarded as a dormant test irradiation region in the search for test irradiation regions, wherein a further test irradiation region is searched for from the remaining irradiation regions not yet sorted into the irradiation sequence, wherein in particular embodiments the dormant test irradiation region is again included in the search for test irradiation regions as soon as a next test irradiation region is sorted into the irradiation sequence. This procedure can be iterated in particular embodiments until a further test irradiation region is found that can both be unambiguously determined and fulfills the shadow casting criterion; this further test irradiation region is then sorted into the irradiation sequence as the next test irradiation region, and all irradiation regions temporarily disregarded as dormant test irradiation regions in the meantime in the search for test irradiation regions are reactivated, i.e., included in the next search for test irradiation regions.

In particular, in one embodiment of the method, a dormant test irradiation region is marked as non-irradiable, in particular by setting a specific value of a specific variable, for example a flag. Alternatively or additionally, the dormant test irradiation region is temporarily removed from a list of irradiation regions not yet sorted into the irradiation sequence. Both measures can ensure that the dormant test irradiation region is not found again for the time being. If the next test irradiation region is then found and sorted into the irradiation sequence, the specific value of the specific variable is reset again and/or the dormant test irradiation region is reinserted into the list of irradiation regions not yet sorted into the irradiation sequence.

According to a further development of embodiments of the invention, the method is carried out for a plurality of energy beams in order to produce the at least one component by means of the plurality of energy beams, wherein at least one displacement region in the working region, in particular embodiments one displacement region in each case, is assigned to each energy beam of the plurality of energy beams, wherein the displacement regions are arranged to be adjacent to one another transversely to the predetermined shielding gas flow direction—in particular embodiments along the transverse axis—above the working region and extend along the shielding gas flow direction—in particular embodiments along the flow axis—wherein the chronological irradiation sequence of the irradiation regions arranged in the displacement regions is determined separately for the displacement regions in each case. In particular embodiments, this has the advantage of automatically preventing adjacent energy beams from coming too close together. This, in turn, advantageously avoids, at least to a large extent, and in preferred embodiments completely prevents, mutual interference between irradiation regions that are irradiated by adjacent energy beams, without the need to introduce waiting times. The manufacture of components can therefore be carried out very efficiently.

In particular embodiments, the determination of the chronological irradiation sequence for the displacement regions is performed independently, i.e., the determination of the irradiation sequence in one displacement region does not depend on the determination or the result of the determination of the irradiation sequence in another displacement region.

In one embodiment, the determination of the chronological irradiation sequence for the displacement regions is performed in parallel. In another embodiment, the determination of the irradiation regions for the displacement regions is performed sequentially, displacement region by displacement region.

In the context of the present technical teaching, a displacement region is understood to be a region or section of the working region in which an energy beam of the plurality of energy beams assigned to the displacement region can be displaced or may be displaced. It is possible that the displacement of the energy beam is technically—in particular embodiments in terms of hardware—limited to the assigned displacement region. Alternatively or additionally, the control of a scanning device provided for the displacement of the energy beam can be limited—in particular embodiments through software—in such a way that the energy beam can only be displaced in the displacement region assigned to it.

In particular embodiments, the displacement regions are unambiguously assigned to the energy beams. In particular embodiments, the displacement regions are biuniquely assigned to the energy beams, i.e., bijectively. This means in particular that exactly one and only one displacement region is assigned to each energy beam, wherein at the same time exactly one and only one energy beam is assigned to each displacement region.

In particular embodiments, the displacement regions are arranged next to one another perpendicular to the predetermined shielding gas flow direction-along the transverse axis-above the working region, and each extend along the predetermined shielding gas flow direction, i.e., along the flow axis.

In particular embodiments, a plurality of irradiation regions is arranged in at least two displacement regions of the plurality of displacement regions in each case. In particular embodiments, a plurality of irradiation regions is arranged in each displacement region in each case.

According to a further development of embodiments of the invention, separate displacement regions are assigned to the energy beams in such a way that the energy beams are displaced only in the displacement regions assigned to them in each case. In particular embodiments, each energy beam can be displaced exclusively in the displacement region assigned to it in this regard and not in another displacement region assigned to another energy beam. This advantageously allows the method to be carried out in a particularly simple and less computationally intensive manner.

In particular embodiments, directly adjacent displacement regions are separated from one another by an imaginary boundary line.

In one embodiment, the imaginary boundary line runs parallel to the predetermined shielding gas flow direction, in particular to the flow axis. In particular embodiments, the imaginary boundary line is a straight line that extends, in particular, parallel to the flow axis.

According to a further development of embodiments of the invention, the energy beams are assigned displacement regions overlapping in regions. In particular embodiments, an overlap region arranged between two directly adjacent displacement regions is defined by the fact that both energy beams assigned to the directly adjacent displacement regions in each case can be displaced in the overlap region; the overlap region is therefore accessible for both energy beams. This advantageously allows for a particularly flexible design of the method and in particular a flexible arrangement of the irradiation regions relative to one another, which can, in particular embodiments, also be arranged in an interleaved or staggered manner in the overlap region. This, in turn, allows for a particularly efficient utilization of the working region and thus overall efficient process control in the production of components. In particular embodiments, an imaginary boundary line is assigned to each displacement region, wherein the boundary line of a displacement region is arranged within an adjacent displacement region, and wherein two boundary lines assigned to adjacent displacement regions enclose the overlap region between them.

According to a further development of embodiments of the invention, starting from a regional position of an irradiation region, the first blocking region is defined on the working region, wherein irradiation with an energy beam is only released for the irradiation region arranged at the regional position when either no other irradiation region is arranged in the first blocking region, or when other irradiation regions arranged in the first blocking region have been irradiated. In this way, it can advantageously be prevented that material from the irradiation region arranged at the regional position, for example spatter, smoke or fumes, is introduced into an irradiation region that may be arranged in the first blocking region but has not yet been irradiated. This means that particularly high-quality components can be produced.

According to a further development of embodiments of the invention, starting from an energy beam position of a first energy beam, a second blocking region is defined on the working region, wherein irradiation with a second energy beam is blocked for the second blocking region. In this way, it can advantageously be prevented that the first energy beam operates in a trail or plume of smoke from the second energy beam and thus is negatively influenced, in particular deflected or defocused. In particular embodiments, each energy beam is assigned such a second blocking region.

In particular embodiments, the second blocking region is displaced with a displacement of the first energy beam on the working region. The second blocking region therefore, in particular embodiments, travels across the working region with the first energy beam.

According to a further development of embodiments of the invention, prior to determining the chronological irradiation sequence, the irradiation regions are arranged in the working region, in particular in the displacement regions, wherein a first chronological irradiation sequence is defined, wherein the arrangement of the irradiation regions in the working region is changed on the basis of the determined first irradiation sequence, wherein a changed arrangement of the irradiation regions is obtained. In particular embodiments, the irradiation of the working region is optimized in this way—preferably in an iterative manner. In particular, the arrangement of the irradiation regions in the working region is changed—in particular in an iterative manner—in such a way that a total irradiation time is optimized, in particular minimized. In this manner, a manufacturing method using the irradiation plan can be made particularly efficient.

In one embodiment, displacement regions overlapping in regions are assigned to the energy beams, and the irradiation regions are arranged in the displacement regions prior to determining the chronological irradiation sequence, wherein the first chronological irradiation sequence is defined, wherein the arrangement of the irradiation regions in the working region is changed based on the first irradiation sequence, wherein a changed arrangement of the irradiation regions is obtained. Advantageously, in particular embodiments in this way, the irradiation regions in the at least one overlap region can be arranged in an interleaved or staggered manner between mutually overlapping displacement regions, whereby the working region can be utilized very efficiently. In particular embodiments, assuming that each energy beam requires approximately the same time to irradiate an equal volume of powder material, an approximate instantaneous position of the energy beams is known or can be determined for each point in time of irradiation based on the first irradiation sequence in this regard. This means that—in particular embodiments by introducing the second blocking region for the energy beams—mutual interference between the energy beams can also be avoided without the need for a hard boundary line between the displacement regions. The more precisely the energy beams can be controlled or the more precisely their positions are known, the wider the respective overlap region which can be selected.

According to a further embodiment of embodiments of the invention, a second chronological irradiation sequence of the irradiation regions is defined for the changed arrangement of the irradiation regions, wherein the irradiation plan is obtained. In particular embodiments, the irradiation of the working region is optimized in this way—preferably in an iterative manner. In particular, the second irradiation sequence is defined—in particular in an iterative manner—in such a way that the total irradiation time is optimized, in particular minimized. In particular embodiments in this manner, a manufacturing method using the irradiation plan can be made particularly efficient.

According to a further development of embodiments of the invention, a first chronological irradiation sequence is defined, wherein a second irradiation sequence is defined on the basis of the first irradiation sequence—in particular without changing the arrangement of the irradiation regions—in particular taking into account at least one blocking region, in particular selected from the first blocking region and the second blocking region, and/or taking into account further parameters or criteria, in particular a utilization of the individual energy beams. In particular embodiments, the irradiation of the working region is also optimized in this way—preferably in an iterative manner. In particular, the second irradiation sequence is defined—in particular in an iterative manner—in such a way that the total irradiation time is optimized, in particular minimized. In particular embodiments in this manner, a manufacturing method using the irradiation plan can also be made particularly efficient.

In one embodiment, the irradiation plan is obtained as a data set for controlling a manufacturing device, in particular embodiments a manufacturing device according to embodiments of the invention described below or a manufacturing device according to one or more of the embodiments described below, for additively manufacturing a component from the powder material. Irrespective of whether the method is carried out on a planning device arranged separately from a manufacturing device or on the manufacturing device itself, the irradiation plan is obtained in this way in an easily manageable, in particular embodiments machine-readable form. In particular embodiments, it is also preferably possible to export the irradiation plan received as a data set and to transport it, in particular to transmit it, independently of a specific device, for example physically on a data carrier or virtually via a network.

Embodiments also create a method—hereinafter also referred to as a manufacturing method—for additively manufacturing at least one component from a powder material, which has the following steps: providing an irradiation plan, obtained with the help of a planning method according to the invention or a planning method according to one or more of the embodiments described above for the locally selective irradiation of a working region with at least one energy beam in order to produce the component layer by layer from a plurality of powder material layers of the powder material arranged chronologically one after another in the working region by means of the at least one energy beam, and manufacturing the at least one component according to the irradiation plan, in particular embodiments by means of the manufacturing device according to embodiments of the invention described below or a manufacturing device according to one or more of the embodiments described below. In connection with the manufacturing method, the advantages that have already been described in connection with the planning method are particularly significant.

In one embodiment, the irradiation plan is provided by carrying out a planning method according to the invention or a planning method according to one or more of the previously described embodiments. The manufacturing method thus also comprises the planning method—in particular embodiments in the form of steps prior to the actual manufacturing process.

The at least one energy beam is, in a preferred embodiment, a laser beam or an electron beam.

The component is, in a preferred embodiment, manufactured by way of selective laser sintering and/or selective laser melting.

A metal or ceramic powder in particular embodiments can preferably be used as powder material.

Embodiments of the invention can also include a first computer program product comprising machine-readable instructions, on the basis of which a planning method according to embodiments of the invention or a planning method according to one or more of the embodiments described above is carried out on a computing device when the first computer program product is executed on the computing device. In connection with the first computer program product, the advantages that have already been described in connection with the planning method or the manufacturing method are particularly significant.

Embodiments of the invention can also include a first data carrier comprising such a first computer program product.

Embodiments of the invention can also include a second computer program product comprising machine-readable instructions, on the basis of which a manufacturing method according to embodiments of the invention or a manufacturing method according to one or more of the embodiments described above is carried out on a computing device when the second computer program product is executed on the computing device. In connection with the second computer program product, the advantages that have already been described in connection with the planning method or the manufacturing method are particularly significant.

Embodiments of the invention can also include a second data carrier comprising such a second computer program product.

Embodiments of the invention also create a planning device for planning a locally selective irradiation of a working region with at least one energy beam in order to produce at least one component from a powder material arranged in the working region by means of the at least one energy beam, wherein the planning device is designed to carry out a planning method according to embodiments of the invention or a planning method according to one or more of the embodiments described above. In connection with the planning device, the advantages that have already been described in connection with the planning method or the manufacturing method are particularly significant.

In particular embodiments, the planning device can be designed to plan the locally selective irradiation of the working region with a plurality of energy beams.

In one embodiment, the planning device is designed as a device selected from a group consisting of a computer, in particular embodiments a personal computer (PC), a plug-in card or control card, and an FPGA board. In one embodiment, the planning device is an RTC5 or RTC6 control card from SCANLAB GmbH, in particular in the current configuration obtainable on the priority date of the present property right.

In particular embodiments, the planning device can be provided externally or separately to a manufacturing device, wherein a data set is preferably created by the planning device, which is then transmitted in a suitable manner, for example by means of a data carrier or via a network, in particular via the Internet, or via another suitable wireless or wired transmission form, to a manufacturing device, in particular a control device of a manufacturing device. For example, it is possible for the planning device to generate CAM data from CAD data, i.e., in particular embodiments a command sequence, in particular an NC program, for controlling the manufacturing device, wherein this command sequence is then transmitted to the manufacturing device for controlling it. It is also possible for CAD data of a component to be transferred to the planning device, wherein the planning device generates the command sequence for the manufacturing device from this. However, the planning device can also be integrated into a manufacturing device. In particular embodiments, the planning device can be integrated into the control device of the manufacturing device, or the control device of the manufacturing device can be designed as a planning device, in particular by providing a suitable hardware component and/or by implementing a suitable computer program product, in particular software. For example, it is possible for CAD data of a component to be produced to be transferred to the manufacturing device, wherein the manufacturing device itself, in particular embodiments the planning device implemented in the control device, generates corresponding CAM data or a command sequence for controlling the manufacturing device from the CAD data. However, it is also possible that the planning device comprises a plurality of computing devices, wherein it is designed in particular as physically distributed. In a preferred embodiment, the planning device then comprises a plurality of networked computing devices. In particular embodiments, the planning device can be designed as a data cloud or what is termed the cloud, or the planning device can be part of a data cloud or cloud. In a preferred embodiment, it is also possible for the planning device to comprise, on the one hand, at least one computing device external to the manufacturing device and, on the other hand, the manufacturing device, in particular embodiments the control device of the manufacturing device, wherein steps carried out by the planning device are then performed partly on the external computing device and partly on the manufacturing device, in particular on the control device. In particular embodiments, it is also possible that the planning device does not transfer the complete planning of the locally selective irradiation of the working region, but only parts thereof; in particular embodiments, it is possible that the planning device only transfers that part of the planning of the locally selective irradiation of the working region which relates to the steps and/or definitions described above. Other parts of the planning of the locally selective irradiation, on the other hand, can be carried out in other computing devices, in particular embodiments in computing devices external to the manufacturing device, or also on the manufacturing device itself, in particular its control device, or also in a data cloud or cloud. In particular embodiments, it is possible for the planning device to change, adapt or correct CAM data or a command sequence, in particular an NC program, generated by another computing device.

Embodiments of the invention also create a manufacturing device for additively manufacturing components from a powder material, which has at least one beam generating device, wherein the at least one beam generating device is designed to generate at least one energy beam. In addition, the manufacturing device has at least one scanning device which is designed to locally selectively irradiate a working region with the at least one energy beam in order to produce at least one component from the powder material arranged in the working region by means of the at least one energy beam. Furthermore, the manufacturing device has a shielding gas device which is designed to produce a shielding gas flow with a defined shielding gas flow direction over the working region. Finally, the manufacturing device has a control device which is operatively connected to the at least one scanning device and designed to control the at least one scanning device. The control device is designed to carry out a manufacturing method according to embodiments of the invention or a manufacturing method according to one or more of the embodiments described above. In connection with the manufacturing device, the advantages that have already been described in connection with the planning method or the manufacturing method are particularly significant.

In particular embodiments, the manufacturing device has a coating device which can be displaced over the working region along a coating displacement direction—in particular aligned along the transverse axis, also referred to as the x-axis—in order to coat the working region with powder material.

In one embodiment, the beam generating device is designed to generate a plurality of energy beams, and/or the manufacturing device has a plurality of beam generating devices for generating a plurality of energy beams. It is possible that a plurality of scanning devices are provided for the plurality of energy beams. However, it is also possible that the scanning device is set up to displace a plurality of energy beams—in particular independently of one another—onto the working region. In particular embodiments, the scanning device can have a plurality of separately controllable scanners, in particular scanner mirrors, for this purpose.

The scanning device, in a preferred embodiment, has at least one scanner, in particular a galvanometer scanner, a piezo scanner, a polygon scanner, a MEMS scanner, and/or a working head or processing head movable relative to the working region. The scanning devices proposed here are particularly suitable for displacing the energy beam within the working region between a plurality of irradiation positions.

A working head or processing head which is movable relative to the working region is understood here to mean an integrated component of the manufacturing device which has at least one radiation outlet for at least one energy beam, wherein the integrated component, that is to say the working head, is movable as a whole along at least one displacement direction, preferably along two mutually perpendicular displacement directions, relative to the working region. Such a working head can in particular embodiments be designed as a gantry or be guided by a robot. The working head may in particular be designed as a robot hand of a robot.

The control device is, in a preferred embodiment, selected from a group consisting of a computer, in particular a personal computer (PC), a plug-in card or control card, and an FPGA board. In a preferred embodiment, the control device is an RTC5 or RTC6 control card from SCANLAB GmbH, in particular in the current configuration obtainable on the priority date of the present property right.

In a preferred embodiment, the at least one beam generating device has at least one laser. The at least one energy beam is thus advantageously generated as an intense beam of coherent electromagnetic radiation, in particular embodiments coherent light. In this respect, irradiation preferably means laser exposure.

The manufacturing device is, in a preferred embodiment, designed for selective laser sintering. As an alternative or in addition, the manufacturing device is designed for selective laser melting. These embodiments of the manufacturing device have proven to be particularly advantageous.

Embodiments of the invention are explained in more detail below with reference to the drawings.

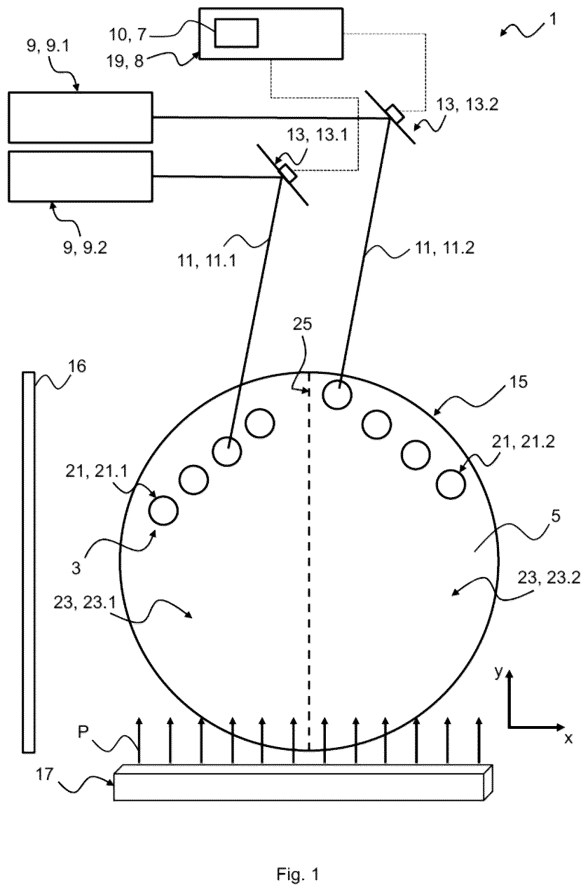

FIG. 1 shows a schematic representation of an exemplary embodiment of a manufacturing device 1 for additively manufacturing at least one component 3 from a powder material 5 with an exemplary embodiment of a planning device 7.

The manufacturing device 1 has at least one beam generating device 9, preferably designed as a laser, which is designed to generate at least one energy beam 11, in particular a laser beam, here in particular a plurality of energy beams 11, and also at least one scanning device 13, which is designed to locally selectively irradiate a working region 15 with the at least one energy beam 11 in order to produce the at least one component 3 from the powder material 5 arranged in the working region 15 by means of the at least one energy beam 11. In particular, the beam generating device 9 generates more than one energy beam 11, or the manufacturing device 1 has more than one beam generating device 9 for generating a plurality of energy beams 11; FIG. 1 specifically shows a first beam generating device 9.1 for generating a first energy beam 11.1 and a second beam generating device 9.2 for generating a second energy beam 11.2. Preferably, the manufacturing device 1 has a separate scanning device 13 for each energy beam 11, specifically a first scanning device 13.1 for the first energy beam 11.1 and a second scanning device 13.2 for the second energy beam 11.2. The manufacturing device 1 has a coating device 16—in particular in the form of a slider—wherein the coating device 16 can be displaced along a coating displacement direction, here in particular along a transverse axis also referred to as the x-axis, over the working region 15 in order to coat the working region 15 with powder material. The manufacturing device 1 also has a shielding gas device 17, which is designed to produce a shielding gas flow with a defined shielding gas flow direction, shown by an arrow P, along a flow axis, also known as the y-axis, over the working region 15. The manufacturing device 1 furthermore has a control device 19, which is designed in particular as a computing device 8, is operatively connected to the at least one scanning device 13 and preferably also to the at least one beam generating device 9 and is designed to control the at least one scanning device 13 and, if appropriate, the at least one beam generating device 9. In this regard, the control device 19 is designed to carry out a method, described in more detail below, for planning the locally selective irradiation of the working region 15 with the energy beams 11, also referred to as the planning method for short.

In particular, the control device 19 has the planning device 7 for this purpose, which is designed in particular as a further computing device 10 and is designed accordingly for carrying out the planning process. Alternatively, it is possible for the control device 19 itself to be designed as the planning device 7. However it is also possible for the planning method to be carried out on a planning device 7 provided separately from the manufacturing device 1.

The control device 19 is also preferably operatively connected to the coating device 16 in order to control the coating device 16 for coating the working region 15 with powder material.

In particular, the manufacturing device 1 is designed to build up the at least one component 3 layer by layer from a plurality of powder material layers arranged chronologically one after another in a layer sequence in the working region 15. For this purpose, the working region 15, in particular in the form of a powder bed, is arranged on a building platform, which is lowered step by step against a vertical direction as the powder material layers are supplied to the working region 15 chronologically one after another. The powder material 5 forming the next powder material layer in each case is conveyed along the x-axis from a region of a storage cylinder into the working region 15 by means of the coating device 16, which is designed in particular as a wiper or pusher, and is distributed and smoothed there by the coating device 16 so that the respectively current powder material layer is provided. By successively locally solidifying the powder material 5 in this manner, powder material layer by powder material layer, by means of the at least one energy beam 11 in the working region 15, the at least one component 3 is built up in layers, i.e., layer by layer.

As part of a method for manufacturing the at least one component 3 from the powder material 5, in particular an irradiation plan obtained with the aid of the planning method described below is provided for the locally selective irradiation of the working region 15 with the at least one energy beam 11, and the at least one component 3 is manufactured in accordance with the provided irradiation plan. In this regard, the irradiation plan is preferably provided by carrying out the planning method—in particular using the planning device 7.

As part of the planning method, in particular, a chronological irradiation sequence of an irradiation of a plurality of irradiation regions 21 with the at least one energy beam 11 for at least one powder material layer is determined using at least two sequence criteria, wherein the fact that irradiation regions 21 which have a smaller x-coordinate value along the x-axis are irradiated chronologically before irradiation regions 21 which have a larger x-coordinate value along the x-axis is used as a first sequence criterion, wherein the fact that irradiation regions 21 which have a larger y-coordinate value along the y-axis are irradiated chronologically before irradiation regions 21 which have a smaller y-coordinate value along the y-axis is used as a second sequence criterion.

In particular, a chronological irradiation sequence is defined for each of a plurality of powder material layers in each case. In particular, an irradiation plan is thus obtained for a plurality of the powder material layers. In particular, this procedure is carried out for all powder material layers of the plurality of powder material layers.

In one embodiment of the planning method, in particular, each energy beam 11 of a plurality of energy beams 11 is assigned a displacement region 23 in the working region 15. In the exemplary embodiment shown here, a first displacement region 23.1 is assigned to the first energy beam 11.1, and a second displacement region 23.2 is assigned to the second energy beam 11.2. The displacement regions 23.1, 23.2 are arranged transversely, here in particular along the x-axis above the working region 15 next to one another and extend along the y-axis, wherein they are delimited from one another by an imaginary boundary line 25. Here, the imaginary boundary line 25 is a straight line that runs parallel to the y-axis.

In particular, multiple first irradiation regions 21.1 are arranged in the first displacement region 23.1, wherein four first irradiation regions 21.1 are schematically shown here, of which only one is marked with the corresponding reference symbol for the sake of clarity. Multiple second irradiation regions 21.2 are arranged in the second displacement region 23.2, wherein four second irradiation regions 21.2 are also schematically shown here, of which only one is marked with the corresponding reference symbol for the sake of clarity.

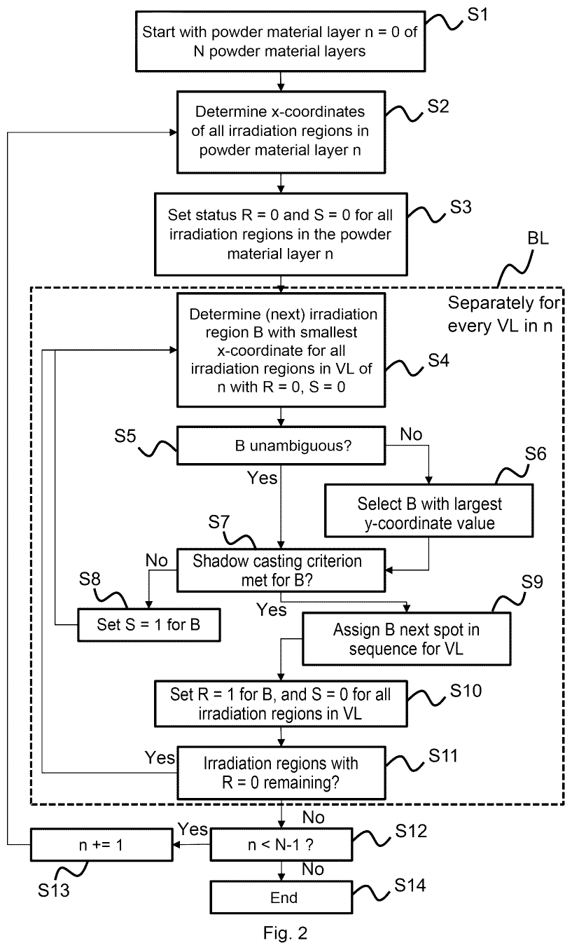

FIG. 2 shows a schematic representation of a first exemplary embodiment of a method for planning a locally selective irradiation of the working region 15 with the energy beams 11.

Elements that are the same or functionally equivalent are provided with the same reference symbols in all of the figures so that in this regard reference is respectively made to the preceding description.

In particular, the method starts with a first step S1, wherein the planning of the irradiation for a first powder material layer n=0 of N powder material layers is started.

In a second step S2, the respectively assigned x-coordinate values are determined for all irradiation regions 21 in the current powder material layer n, wherein in particular the smallest x-coordinate value or—in other words—the point of an edge of the respective irradiation region 21 arranged furthest to the left on the x-axis according to FIG. 1 is used for each irradiation region 21.

In a third step S3, a sequence status R is set to the value 0 (R=0) and a shadow casting status S is also set to the value 0 (S=0) for all irradiation regions 21 in the powder material layer n.

The method is then carried out separately, in particular in parallel, for each displacement region 23 (VL), as explained below by way of example for a displacement region 23 in the block BL in FIG. 2.

In a fourth step S4, from all irradiation regions 21 of the considered displacement region 23 of the current powder material layer n, to which the following applies: R=0 AND S=0, an irradiation region with the smallest x-coordinate value is determined as test irradiation region B.

In a fifth step S5, it is checked whether the test irradiation region B can be unambiguously determined. If this is not the case, in a sixth step S6, that irradiation region is determined as the test irradiation region B which, in addition to the smallest x-coordinate value, has the largest y-coordinate value, wherein here, too, the largest y-coordinate value or—in other words—the point of the edge of the respective irradiation region 21 arranged furthest up on the y-axis according to FIG. 1 is used for each considered irradiation region 21.

If the test irradiation region B is then determined—either already unambiguously from the fifth step S5 or by the further definition in the sixth step S6—a seventh step S7 checks whether no further irradiation region 21 not yet sorted into the irradiation sequence is arranged in a first blocking region in the shielding gas flow direction downstream of the test irradiation region B, i.e., along the y-axis behind the test irradiation region B. This criterion is also referred to as the shadow casting criterion.

If the shadow casting criterion is not met, the shadow casting status S is set to 1 in an eighth step S8 (S=1). This has the effect that the test irradiation region B, as a dormant test irradiation region, is provisionally disregarded in the search for test irradiation regions. The method is then continued in the fourth step S4—with the remaining irradiation regions 21 to which the following still applies: R=0 AND S=0. Steps S4 to S8 can be iterated in particular until a test irradiation region B is found for which the shadow casting criterion in the seventh step S7 is met.

If the shadow casting criterion is met in the seventh step S7 for a test irradiation region B, this test irradiation region B is assigned the next spot in the irradiation sequence in a ninth step S9.

Then, in a tenth step S10, the sequence status R is set to the value 1 (R=1) for the test irradiation region B sorted into the irradiation sequence in the ninth step S9, and the shadow casting status S is set back to the value 0 (S=0) for all currently dormant test irradiation regions so that the affected irradiation regions 21 are again included in the search for test irradiation regions the next time the fourth step S4 is called. As a result, all irradiation regions 21 in the considered displacement region then again have the shadow casting status S=0.

In an eleventh step S11, it is then checked whether there are still irradiation regions 21 for which the sequence status R has the value 0, i.e., which are not yet sorted into the irradiation sequence. If this is the case, the method is continued with the fourth step S4. In this manner, the irradiation regions 21 are successively sorted into the irradiation sequence. If, on the other hand, there are no more irradiation regions 21 for which the sequence status R has the value 0, this means that all irradiation regions 21 of the considered displacement region 23 have been sorted into the irradiation sequence.

The method is then continued with a twelfth step S12. This step checks whether the index value n of the current powder material layer is less than N−1. If this is the case, the index n is incremented in a second step S13, and the method is continued in the second step S2 for the next powder material layer. If, on the other hand, the index value n=(N−1) in the twelfth step S12, this means that the method has been carried out for all N powder material layers, which is why it is ended in a fourteenth step S14.

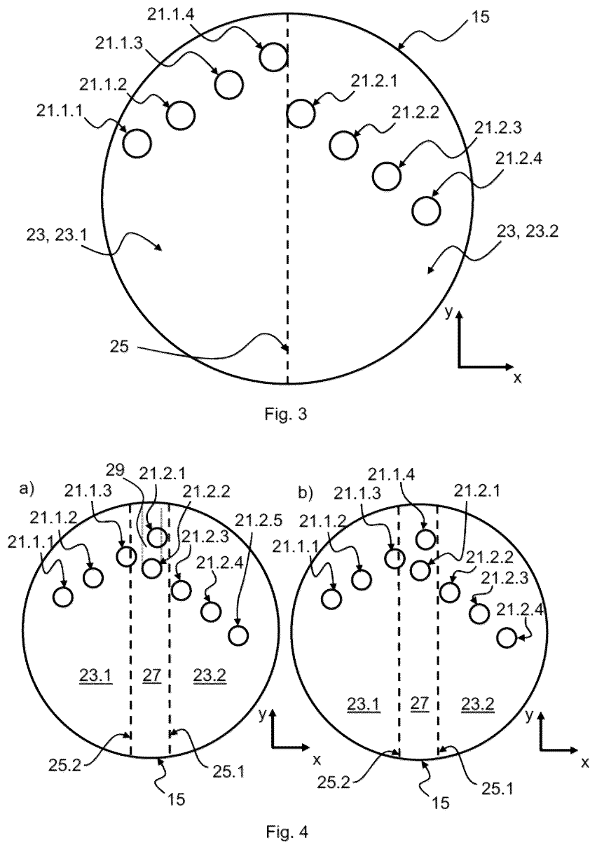

FIG. 3 shows a schematic representation of a first application of the planning method according to FIG. 2 in the working region 15.

FIG. 3) shows an exemplary embodiment in which the energy beams 11 are assigned separate displacement regions 23 in such a way that the energy beams 11 are displaced exclusively in the displacement regions 23 assigned to them in each case. In particular, the first energy beam 11.1 can be displaced exclusively in the first displacement region 23.1 in this regard and not in the second displacement region 23.2. The second energy beam 11.2 can be displaced exclusively in the second displacement region 23.2 and not in the first displacement region 23.1. In particular, the directly adjacent displacement regions 23.1, 23.2 are separated from one another by the imaginary boundary line 25.

The application of the planning method according to FIG. 2 to the irradiation regions 21 shown in FIG. 3 readily results in an irradiation sequence in the first displacement region 23.1 in which a first first irradiation region 21.1.1 is irradiated first, followed by a second first irradiation region 21.1.2, followed by a third first irradiation region 21.1.3, followed by a fourth first irradiation region 21.1.4. Accordingly, an irradiation sequence results in the second displacement region 23.2, in which a first second irradiation region 21.2.1 is irradiated first, followed by a second second irradiation region 21.2.2, followed by a third second irradiation region 21.2.3, followed by a fourth second irradiation region 21.2.4.

FIG. 4 shows a schematic representation of a second application of the planning method according to FIG. 2 in the working region 15.

FIG. 4 shows an exemplary embodiment in which the energy beams 11 are assigned displacement regions 23 overlapping in regions. In particular, an overlap region 27 arranged between the directly adjacent displacement regions 23.1, 23.2 is defined by the fact that both energy beams 11.1, 11.2 can be displaced in the overlap region 27. Otherwise—outside of the overlap region 27—however, the displacement of the energy beams 11.1, 11.2 is limited to the respectively assigned displacement regions 23.1, 23.2. The first displacement region 23.1 is delimited here by a first imaginary boundary line 25.1—to the right in the figure; the second displacement region 23.2 is delimited by a second imaginary boundary line 25.2—to the left in the figure.

A first application of the planning method according to FIG. 2 to the irradiation regions 21 shown in FIG. 4 leads—as shown in a)—initially to a first irradiation sequence for the first displacement region 23.1, in which a first first irradiation region 21.1.1 is irradiated first by the first energy beam 11.1, then a second first irradiation region 21.1.2, then a third first irradiation region 21.1.3; at the same time, a first irradiation sequence results for the second displacement region 23.2, in which a first second irradiation region 21.2.1 is irradiated first by the second energy beam 11.2, then a second second irradiation region 21.2.2, then a third second irradiation region 21.2.3, then a fourth second irradiation region 21.2.4, and then a fifth second irradiation region 21.2.5.

An optimization of the total irradiation time, preferably subsequently carried out on the basis of this first irradiation sequence, in particular taking into account a utilization of the energy beams 11 that is as uniform as possible, preferably leads to a re-sorting and changing of the irradiation sequence, which then results—as shown in b)—in a second irradiation sequence for the first displacement region 23.1, in which a first first irradiation region 21.1.1 is first irradiated by the first energy beam 11.1, then a second first irradiation region 21.1.2, then a third first irradiation region 21.1.3, then a fourth first irradiation region 21.1.4; for the second displacement region 23.2, a second irradiation sequence results, in which a first second irradiation region 21.2.1 is first irradiated by the second energy beam 11.2, then a second second irradiation region 21.2.2, then a third second irradiation region 21.2.3, then a fourth second irradiation region 21.2.4.

Alternatively or additionally, based on the first irradiation sequences, the arrangement of the irradiation regions 21 in the working region 15 can be changed, wherein a changed arrangement of the irradiation regions 21 is obtained. In particular, the second irradiation sequence can be defined for the changed arrangement of the irradiation regions 21.

Advantageously, in particular due to this optimization, the irradiation regions 21 in the overlap region 27 can be arranged in an interleaved or staggered manner between the mutually overlapping displacement regions 23, whereby the working region 15 can be utilized very efficiently.

It is preferably provided that, starting from a regional position of an irradiation region 21, a first blocking region 29—shown schematically in a) for the second second irradiation region 21.2.2—is defined on the working region 15, wherein irradiation with an energy beam 11 is only released for the irradiation region 21 arranged at the regional position when either no other irradiation region 21 is arranged in the first blocking region 29, or when other irradiation regions 21 arranged in the first blocking region 29 have already been irradiated.

Preferably, it is alternatively or additionally provided that, starting from an energy beam position of one of the energy beams 11, a second blocking region is defined on the working region 15, wherein irradiation with another energy beam 11 is blocked for the second blocking region. In particular, such a second blocking region is defined for each of the energy beams 11.

In an exemplary embodiment, prior to defining the chronological irradiation sequence, the irradiation regions 21 can be arranged in the working region 15, in particular in the displacement regions 23, wherein a first chronological irradiation sequence is defined, wherein the arrangement of the irradiation regions 21 in the working region 15 is changed on the basis of the first irradiation sequence, wherein a changed arrangement of the irradiation regions 21 is obtained.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for planning a locally selective irradiation of a working region with at least one energy beam in order to produce, by the at least one energy beam, at least one component layer by layer from a plurality of powder material layers of a powder material arranged chronologically one after another in a layer sequence in the working region, comprising:
determining, for at least one powder material layer based on at least two sequence criteria, a chronological irradiation sequence of an irradiation of a plurality of irradiation regions with the at least one energy beam;
using, as a first sequence criterion, a first irradiation chronology wherein irradiation regions of the plurality of irradiation region which have a smaller transverse axis coordinate value along a transverse axis oriented transverse to a predetermined shielding gas flow direction over the working region are irradiated chronologically before irradiation regions which have a larger transverse axis coordinate value along the transverse axis;
using, as a second sequence criterion, a second irradiation chronology wherein irradiation regions of the plurality of irradiation regions which have a larger flow axis coordinate value along a flow axis pointing in the shielding gas flow direction are irradiated chronologically before irradiation regions which have a smaller flow axis coordinate value along the flow axis; and
obtaining an irradiation plan for the locally selective irradiation of the working region with the at least one energy beam in the at least one powder material layer.

2. The method according to claim 1, wherein the transverse axis is aligned along a coating displacement direction of a coating device designed for coating the working region with the powder material.

3. The method according to claim 1, wherein the irradiation regions are successively sorted into the chronological irradiation sequence, wherein at least one test irradiation region with a smallest transverse axis coordinate value is sought from the irradiation regions not yet sorted into the irradiation sequence, and wherein the test irradiation region is sorted into the chronological irradiation sequence when the test irradiation region is unambiguously determined and no further irradiation region not yet sorted into the chronological irradiation sequence is arranged in a first blocking region in the shielding gas flow direction downstream of the test irradiation region.

4. The method according to claim 3, wherein, when the test irradiation region is not determined unambiguously, that irradiation region of the irradiation regions not yet sorted into the chronological irradiation sequence is determined as the test irradiation region which has the smallest transverse axis coordinate value and at the same time a largest flow axis coordinate value.

5. The method according to claim 3, wherein, when a further irradiation region not yet sorted into the chronological irradiation sequence is arranged in the first blocking region downstream of the test irradiation region in the shielding gas flow direction, the test irradiation region is provisionally disregarded as a dormant test irradiation region in a search for the test irradiation region, wherein a further test irradiation region is searched for from remaining irradiation regions not yet sorted into the chronological irradiation sequence, wherein the dormant test irradiation region is again included in the search for the test irradiation region as soon as a next test irradiation region is sorted into the chronological irradiation sequence.

6. The method according to claim 1, wherein the method is carried out for a plurality of energy beams comprising the at least one energy beam in order to produce the at least one component by means of the plurality of energy beams, wherein at least one displacement region in the working region is assigned to each energy beam of the plurality of energy beams, wherein the displacement regions are arranged to be adjacent to one another transversely to the predetermined shielding gas flow direction above the working region and extend along the shielding gas flow direction, and wherein the chronological irradiation sequence for the displacement regions is determined separately in each case.

7. The method according to claim 6, wherein separate displacement regions are assigned to respective energy beams of the plurality of energy beams in such a way that the respective energy beams are displaced only in the displacement regions assigned to them in each case, wherein directly adjacent displacement regions are delimited from one another by an imaginary boundary line, and wherein the imaginary boundary line runs parallel to the predetermined shielding gas flow direction; or wherein displacement regions overlapping in regions are assigned to respective energy beams of the plurality of energy beams, wherein in an overlap region arranged between two directly adjacent displacement regions, both respective energy beams assigned to the directly adjacent displacement regions can be displaced.

8. The method according to claim 1, wherein, starting from a regional position of the irradiation region, a first blocking region is defined on the working region, wherein irradiation with an energy beam of the at least one energy beam is only released for the irradiation region arranged at the regional position when no other irradiation region is arranged in the first blocking region, or when other irradiation regions arranged in the first blocking region have been irradiated.

9. The method according to claim 6, wherein, starting from an energy beam position of a first energy beam, a second blocking region is defined on the working region, wherein irradiation with a second energy beam is blocked for the second blocking region, and wherein the second blocking region is displaced with a displacement of the first energy beam on the working region.

10. The method according to claim 1, wherein prior to defining the chronological irradiation sequence, the irradiation regions are arranged in the working region in the displacement regions, wherein a first irradiation sequence is defined, wherein the arrangement of the irradiation regions in the working region is changed based on the first irradiation sequence, and wherein a changed arrangement of the irradiation regions is obtained.

11. The method according to claim 10, wherein a second irradiation sequence is defined for the changed arrangement of the irradiation regions, and wherein the irradiation plan is obtained.

12. The method according to claim 1, wherein a first irradiation sequence is defined, and wherein a second irradiation sequence is defined based on the first irradiation sequence taking into account at least one blocking region.

13. A method for additively manufacturing at least one component from a powder material, comprising the following steps: providing the irradiation plan, obtained based on the method according to claim 1, for the locally selective irradiation of the working region with the at least one energy beam in order to produce the component layer by layer from the plurality of powder material layers of the powder material arranged chronologically one after another in the working region by the at least one energy beam, and manufacturing the at least one component according to the irradiation plan.

14. A planning device for planning a locally selective irradiation of a working region with at least one energy beam in order to produce at least one component from a powder material arranged in the working region by means of the at least one energy beam, the planning device being designed to carry out the method according to claim 1.

15. A manufacturing device for additively manufacturing components from a powder material configured to carry out the method according to claim 13, the manufacturing device comprising:
at least one beam generating device which is designed to produce at least one energy beam;
at least one scanning device which is designed to locally selectively irradiate a working region with the at least one energy beam in order to produce at least one component from the powder material arranged in the working region by the at least one energy beam,
a shielding gas device which is designed to produce a shielding gas flow with a defined shielding gas flow direction over the working region, and comprising a control device which is operatively connected to the at least one scanning device and designed to control the at least one scanning device.
